(19) United States
(12) Patent Application Publication
(10) Pub. No.: US 2005/0099753 A1
(43) Pub. Date: May 12, 2005

(54) Power supply protector for supressing transient voltage

(76) Inventor: Szu-Ping Liu, Saichung City (TW)

Correspondence Address: BACON & THOMAS, PLLC, 625 SLATERS LANE, FOURTH FLOOR, ALEXANDRIA, VA, 22314, US

(21) Appl. No.: 10/704,796

(22) Filed: Nov. 12, 2003

(51) Int. Cl. H02H 9/06

(52) U.S. Cl. 361/118

(57) ABSTRACT

The present invention discloses a power supply protector for suppressing transient voltage, comprising a timer in a control chip of a control circuit such that when the power supply produces a transient voltage to disconnect a suppressor thereof, the timer will count the time according to a predetermined time, and after the counting is completed, the control circuit will send out a trigger signal to the suppressor, so that the suppressor will be triggered by the trigger signal to resume to the original electrically connected status, and further resume the supply of electric power to the electric equipment, and thus attaining the purpose of automatically restoring the electric power after being disconnected for a certain period of time.

### FIELD OF THE INVENTION

The present invention relates to a power supply protector, more particularly to a power supply protector for suppressing transient voltage.

### BACKGROUND OF THE INVENTION

In recent years, the electronics industry and material science are advancing day after day, and numerous new models of electronic components and manufacturing technologies are developed successfully, not only greatly reducing the manufacturing cost of electronic products and effectively improving the functions and quality of electronic products, but also replacing traditional electronic components by various miniaturized semiconductor components due to the continuous advancement of the semiconductor manufacturing technology. These electronic products are developed in the light and compact design to meet the market trend and requirements and greatly enhance the convenience and popularity of the applications of various electronic products.

However, the present electronic devices are generally connected to an external power source (such as the wall outlet) directly without having a protector. When the user turns on the power unexpectedly, a transient voltage of the power supply through the switch (transient voltage surge) will rapidly enter into the internal circuit of such electronic device and may seriously damage such circuit. As a result, it will also damage the electronic device and affect its normal operation.

In view of the foregoing shortcoming about the electronic device being directly connected to the wall outlet and easily damaged by the transient voltage surge of the socket, the inventor of this invention based on years of experience on manufacturing electronic devices to conduct research and development and perform experiments in order to find a solution to overcome the foregoing shortcoming, and finally invented the power supply protector for suppressing transient voltage in accordance with this invention. In the power supply protector according to this invention, one end of the device is connected to a power supply, and the other end has a power supply output terminal being connected to an electric equipment (such as a computer), so that the electric power of the power supply is supplied to the electric equipment through this device. Further, such device comprises a transient voltage suppressor, a control circuit, and a detect circuit for voltage surge, wherein the suppressor is disposed between a power supply and a power supply output terminal, and the control circuit is coupled with the suppressor, and the detect circuit for voltage surge is coupled to the control circuit, such that the control circuit can transmit a trigger signal to the suppressor and such suppressor is triggered to be electrically connected by the trigger signal, and the electric power of the power supply can pass through the suppressor and the power supply output terminal in sequence to the electric equipment.

When the power supply produces an abnormal transient voltage, and the detect circuit for voltage surge detects a transient voltage, the transient voltage will block the control circuit from sending out the trigger signal, so that the suppressor will not be triggered for the disconnection, and further disconnect the power of the power supply for the electric equipment. Therefore, the electric equipment can avoid the impact of the transient voltage due to the disconnection of the suppressor and attain the purpose of protecting the electric equipment.

### SUMMARY OF THE INVENTION

The primary objective of the present invention is to provide a power supply protector, comprising a timer in the control chip of the control circuit such that when the power supply produces a transient voltage to disconnect the suppressor, the timer will count the time according to a predetermined time, and after the counting is completed, the control circuit will send out a trigger signal to the suppressor, so that the suppressor will be triggered by the trigger signal to resume the original electrically connected status, and further resume the supply of electric power to the electric equipment and attain the purpose of automatically restoring the electric power after the power has been disconnected for a certain period of time.

Another objective of the present invention is to provide a power supply protector, comprising a status indicating circuit which further comprises a power indicating circuit, an error indicating circuit, and a normal protection indicating circuit, wherein an indicating light (such as a light emitting diode, LED) of the power indicating circuit emits light when the power supply is supplying electric power to the electric equipment to indicate the normal supply of electric power. An indicating light (such as a LED) of the error indicating circuit emits light when the power supply produces a transient voltage and disconnects the suppressor to indicate the status of the suppressor disconnecting the electric power for protecting the electric equipment. An indicating light (such as a LED) of the normal protection indicating circuit indicates the normal operating status of the control circuit and the suppressor.

### BRIEF DESCRIPTION OF THE DRAWINGS

To make it easier for our examiner to understand the objective of the invention, its structure, innovative features, and performance, we use a preferred embodiment together with the attached drawings for the detailed description of the invention.

FIG. 1 is a block diagram of the present invention.

FIG. 2 is a schematic circuit diagram of the present invention.

### DETAILED DESCRIPTION OF THE PREFERRED EMBODIMENTS

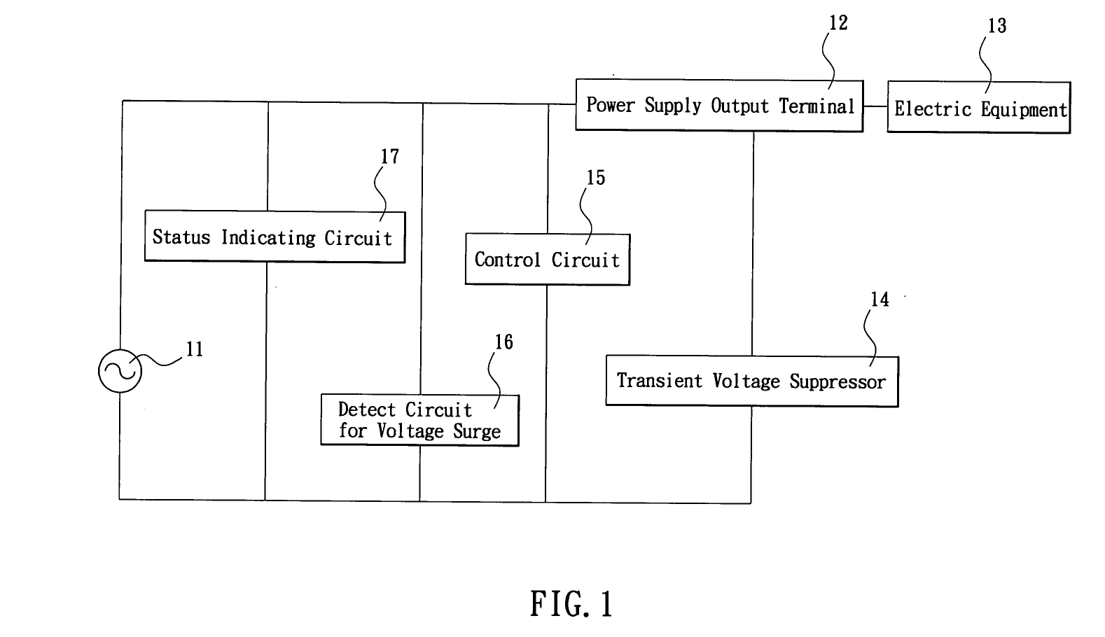

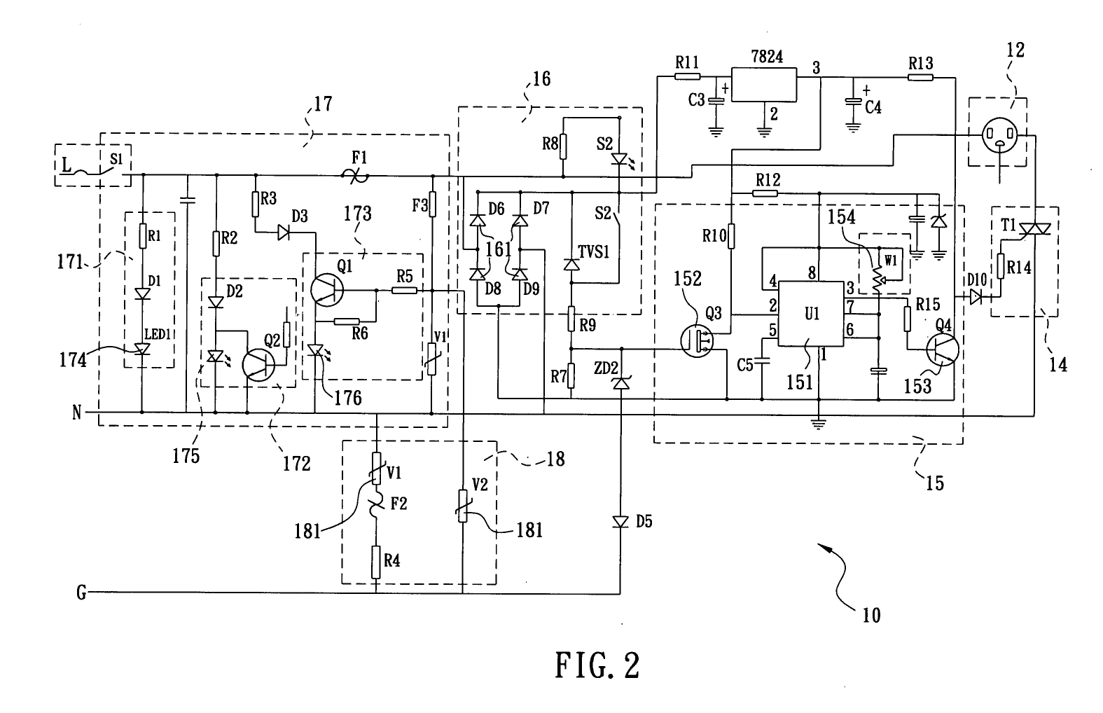

Please refer to FIGS. 1 and 2 for the power supply protector for suppressing transient voltage of the present invention. In the figures, an end of such device 10 is connected to a power supply 11 (such as a wall outlet) and the other end has a power supply output terminal 12 (such as a socket), and the power supply output terminal 12 is connected to an electric equipment 13 (such as a computer, a television, or a stereo, etc.) so that the electric power of the power supply 11 can be supplied to the electric equipment 13 of the device 10.

Please refer to FIGS. 1 and 2 again. The device 10 comprises a transient voltage suppressor (TVS) 14, a control circuit 15, and a detect circuit for voltage surge 16; wherein the transient voltage suppressor 14 is disposed between the power supply 11 and the power supply output terminal 12; the control circuit 15 is connected to the transient voltage suppressor 14; the detect circuit for surge voltage 16 is connected to the control circuit 15, so that the control circuit 15 can send out a trigger signal to the transient voltage suppressor 14, and the transient voltage suppressor 14 is triggered by the trigger signal to be electrically connected, and further supplies electric power to the electric equipment 13 through the transient voltage suppressor 14 and the power supply output terminal 12 in sequence.

Please refer to FIGS. 1 and 2. When the power supply 11 produces an abnormal transient voltage and then the detect circuit for voltage surge 16 detects the transient voltage and sends out a detect signal to the control circuit 15, the detect signal will block the transmission of the trigger signal of the control circuit 15, and the transient voltage suppressor 14 will not be triggered for the disconnection, and thus disconnecting the power of the power supply 11 to the electric equipment 13. Therefore, the electric equipment 13 can avoid the impact of the transient voltage due to the disconnection of the transient voltage suppressor 14 and attain the purpose of protecting the electric equipment 13.

Please refer to FIGS. 1 and 2 again. A control chip 151 of the control circuit 15 has a timer (not shown in the figures). When the power supply 11 produces a transient voltage and the transient voltage suppressor 14 is disconnected, the timer will count the time according to a predetermined time. After the timing is completed, the control circuit 15 is driven to send out a trigger signal to the transient voltage suppressor 14. The transient voltage suppressor 14 is triggered by the trigger signal to resume its original electrically connected status and further recover the power of the power supply 11 to the electric equipment 13 in order to attain the effect of automatically resuming the power after the power disconnection for a certain period of time.

Further, refer to FIGS. 1 and 2. The device 10 comprises a status indicating circuit 17, which further comprises a power supply indicating circuit 171, an error indicating circuit 172, and a normal protection indicating circuit 173; wherein an indicating light 174 (such as a light emitting diode, LED) of the power supply indicating circuit 171 emits light when the power supply 11 supplies electric power to the electric equipment 13 to indicate the normal supply of electric power of the power supply 11. An indicating light 175 (such as a LED) of the error indicating circuit 172 emits light when the power supply 11 produces a transient voltage to indicate the status of the transient voltage suppressor 14 disconnecting the power for the protection of the electric equipment 13. An indicating light 176 (such as a LED) of the normal protection indicating circuit 173 emits light to indicate the normal operation status of the control circuit 15 and the transient voltage suppressor 14.

Please refer to FIG. 2 for the preferred embodiment of this invention. In the figure, the control circuit 15 comprises an amplifier 152, a control chip 151, and a transistor 153, and the detect circuit for voltage surge 16 comprises a plurality of diodes 161; wherein the control chip 151 can produce a trigger signal so that the trigger signal will be transmitted to the transient voltage suppressor 14 through the transistor 153 and the transient voltage suppressor 14 is triggered to be electrically connected by the trigger signal.

When the detect circuit for voltage surge 16 detects a transient voltage, the detect circuit for voltage surge 16 will send out a detect signal to the control circuit 15 so that the signal will be inputted into the transistor 153 by the control chip 151 after the amplifier 152 amplifies the signal, and the amplified signal of the transistor 153 will generate a conductivity saturation to block the trigger signal from being transmitted to the transient voltage suppressor 14, and further blocks the transient voltage suppressor 14 from being triggered and disconnected.

Please refer to FIG. 2 again for the preferred embodiment of this invention. The control circuit 15 further comprises a modulator 154 which could be a variable resistor, and the modulator 154 is electrically coupled to the timer of the control chip 151, so that users can adjust the resistance of the modulator 154. When such adjustment is being made by the timing of the timer, the timer will count the time according a predetermined time. Therefore, the modulator 154 can be used to adjust the time of resuming the electric power.

Please refer to FIG. 2 again for the preferred embodiment of this invention. The device 10 comprises a varistor circuit 18 which comprises at least one capacitor 181, and the capacitors 181 are connected to each other in parallel such that the capacitor 181 can eliminate the surge of a general current, and the power supply 11 can supply normal current to the electric equipment 13 to prevent the electric equipment being damaged by the surge of the current which will cause failure.

In summation of the description above, the power supply protector 10 for suppressing transient voltage in accordance with this invention (as shown in FIGS. 1 and 2) can disconnect the power of the power supply 11 to the electric equipment 13 when the power supply 11 produces a transient voltage, and thus preventing the electric equipment 13 from being impacted by the transient voltage and further attaining the purposes of protecting the electric equipment 13 and having a safe power consumption.

While the invention has been described by means of specific embodiments, numerous modifications and variations could be made thereto by those skilled in the art without departing from the scope and spirit of the invention set forth in the claims.

1. A power supply protector for suppressing transient voltage, of which one end of said power supply protector being coupled to a power supply, and the other end being coupled to a power supply output terminal, and said power supply output terminal being coupled to an electric equipment, such that the power of said power supply supplying electric power to said electric equipment through said power supply protector, comprising:
a transient voltage suppressor, being disposed between said power supply and said power supply output terminal;
a control circuit, being coupled to said transient voltage suppressor, thereby said control circuit being capable of sending a trigger signal to said transient voltage suppressor, and said transient voltage suppressor being triggered by said trigger signal for an electric connection, and further supplying electric power of said power supply to said electric equipment through said transient voltage suppressor and said power output terminal in sequence;
a detect circuit for voltage surge, being coupled to said control circuit; such that when said power supply producing an abnormal transient voltage and letting said detect circuit for voltage surge detect the transient voltage and sending out a detect signal to said control circuit, said detect signal blocking the transmission of said trigger signal from said control circuit, and said transient voltage suppressor not being triggered for a disconnection, and further disconnecting the electric power of the power supply to the electric equipment and thus preventing said electric equipment from being impacted by the transient voltage caused by the disconnection of said transient voltage suppressor.

2. The power supply protector for suppressing transient voltage of claim 1, wherein said control chip of the control circuit comprises a timer, so that when said power supply produces a transient voltage to disconnect the transient voltage suppressor, said timer counts the time according to a predetermined time, and drives said control circuit to send out a trigger signal to said transient voltage suppressor after the timing is completed, and then the transient voltage suppressor is triggered to send out said trigger signal to resume the electrically connected status in order to recover the supply of electric power to said electric equipment.

3. The power supply protector for suppressing transient voltage of claim 1, further comprising a status indicating circuit, and said status indicating circuit comprises a power supply indicating circuit, an error indicating circuit, and a normal protection indicating circuit, wherein an indicating light of said status indicating circuit emitting light when electric power being supplied to said electric equipment to indicate the normal supply of electric power; an indicating light of said error indicating circuit emitting light when said power supply generating a transient voltage to disconnect said transient voltage suppressor to indicate the status of the disconnection of said transient voltage suppressor to protect said electric equipment; and an indicating light of said normal protection indicating circuit emitting light to indicate the normal operating status of said control circuit and said transient voltage suppressor.

4. The power supply protector for suppressing transient voltage of claim 2, wherein said control circuit comprises an amplifier, a control chip, and a transistor; said detect circuit for voltage surge comprises a plurality of diodes, and said control chip produces a trigger signal such that said trigger signal is transmitted to said transient voltage suppressor through said transistor and is triggered by said trigger signal to electrically connect said transient voltage suppressor; when said detect circuit for voltage surge detects a transient voltage, said detect circuit for voltage surge sends out a detect signal to said control circuit, so that after said amplifier amplifies the signal, the signal is inputted into said transistor causing a connectivity saturation to the amplified signal and blocks the trigger signal being sent to said transient voltage suppressor and disconnects said transient voltage suppressor for its not being triggered.

5. The power supply protector for suppressing transient voltage of claim 4, wherein said control circuit further comprises a modulator, being a variable resistor and electrically coupled to the timer of said control chip, such that said timer counts the time according to a predetermined time determined by adjusting the resistance value of said modulator, and thus said modulator is used to adjust the time of resuming the electric power.

6. The power supply protector for suppressing transient voltage of claim 1 further comprising a varistor circuit, which further includes at least one capacitor, and said capacitors are coupled in parallel with each other, so that said capacitor is capable of eliminating a general current surge, and the general current surge produced by said power supply is eliminated by said varistor circuit in order to normally supply electric power to said electric equipment and prevent said electric equipment from being damaged and failed by said current surge.
